(19) United States
(12) Patent Application Publication
(10) Pub. No.: US 2021/0261794 A1
(43) Pub. Date: Aug. 26, 2021

(54) HEAT ACTIVATED REINFORCING FABRIC CONFIGURED FOR INTUMESCENT MATERIAL EXPANSION

(71) Applicant: TEXTUM WEAVING, INC., Belmont, NC (US)

(72) Inventors: James A. CRAWFORD, JR., Wilmington, NC (US); Aaron FEINBERG, Cornelius, NC (US)

(21) Appl. No.: 16/801,386

(22) Filed: Feb. 26, 2020

(51) Int. Cl. C09D 5/18; D03D 1/00; D02G 3/44; C08J 5/04

(52) U.S. Cl. CPC C09D 5/185; D03D 1/0035; E01D 2/02; C08J 5/046; C08J 5/042; D02G 3/443

(57) ABSTRACT

A reinforcing fabric configured for intumescent material expansion includes a woven fabric. The woven fabric has a plurality of composite yarns. Each composite yarn includes a fire resistant component and a crimping component. The crimping component is bonded to the fire resistant component, where the fire resistant component is in a crimped state and the crimping component is in a relaxed state when bonded. The woven fabric is woven with the plurality of the composite yarns with the fire resistant component maintained in the crimped state and the crimping component maintained in the relaxed state in each of the composite yarns. When the woven fabric is imbedded in an intumescent material, the woven fabric is configured to reinforce the intumescent material during heat expansion, and mechanical loads from the expanding intumescent material, in a controlled and predictable manner.

### FIELD OF THE DISCLOSURE

The present disclosure is related to reinforcing fabrics for intumescent materials on structures, like bridge structural elements, exposed pipe in an oil refinery, or the like, that are required to change shape or dimensions in a controlled, predictable way when subjected to elevated temperature and mechanical loads from the expanding intumescent material. More specifically, the present disclosure is directed toward a heat activated reinforcing fabric for intumescent materials configured for use on structures, like bridge structural elements, exposed pipe in an oil refinery, or the like, that are configured to change shape or dimensions in a controlled, predictable way when subjected to elevated temperature and mechanical loads from the expanding intumescent material.

### BACKGROUND

Certain applications for reinforcing fabric require that the fabric change shape or dimensions in a controlled, predictable way when subjected to elevated temperature and mechanical loads from the expanding intumescent material. One example of this is when fabric is used to reinforce an intumescent coating. Intumescent coatings are typically comprised of a polymeric resin loaded with blowing agents and fire retardant chemicals. An open mesh fabric woven with fibers capable of withstanding high temperatures for extended periods of time typically reinforces the coating. The coating can be applied to the fabric using traditional coating techniques in an industrial manufacturing environment. These coated fabrics are delivered to the site where thermal protection is required, where they can be installed by trained technicians. One example of an application is overhead bridge structural elements and another is exposed pipe in an oil refinery. In the case of the bridge structural elements, it is possible for a fuel transport truck to be involved in a traffic accident while under the bridge. If the truck and its cargo catch on fire, the heat from the fire could destroy the bridge structure causing traffic disruption for several days or weeks until repairs are made. A similar scenario can be described for exposed piping in an oil refinery.

The intumescent coated fabric can protect the structure over which it is covered from high temperature exposure. The covering in the examples cited would be in the form of a fabric wrap. The chemicals in the coating react when exposed on the surface to the high temperature threatening gases. The thickness of the coating and the chemical make-up of the coating can be selected for the type of threat envisioned. The blowing agent in the coating causes the outer surface of the coating layer to expand in thickness. The added thickness, in part, provides thermal insulation. When this outer layer of coating exceeds its time at temperature limitation, the coating layer below becomes exposed to the elevated temperature which triggers another round of expansion with the attendant thermal protection.

The role that the reinforcing fabric plays is an important one. Primarily, the coating itself has very little structural integrity when exposed to the elevated temperatures. The fabric, therefore, reinforces the coating and since the fabric is woven with high temperature fibers such as carbon or ceramic, for example, the reinforcement factor is retained throughout the performance of the intumescent coating. Another important feature of the fabric is the open mesh construction mentioned earlier. The openings in the fabric can be tailored for the application but are typically on the order of one-quarter of an inch square. These openings allow the expansion of the intumescent material to grow, at least partially, through the fabric. In this manner, the fabric still provides reinforcement to the coating. Another important feature of the reinforcement fabric is that it needs to expand in dimension so as to not restrict the expansion as the coating thickness increases due to the blowing agent expansion. This growth in fabric dimension must not eliminate the ability of the reinforcing fabric to carry load, i.e. it must retain its ability to reinforce the intumescent coating. A current reinforcing material used in this manner to reinforce an intumescent coating is woven with carbon fibers that are comprised of short staple length spun yarns. The yarns are spun by plying and twisting short (approximately 1.5 inches in length) oxidized polyacrylonitrile (PAN) fibers. These fibers are often referred to as pre-ox fibers. At this state, the yarns are handleable and can be woven into a variety of fabric designs, including into open mesh designs as required in the above examples. However, the pre-ox fibers are not capable of maintaining their thermal stability at high temperature as they have not been fully carbonized, i.e. they are not yet carbon fibers. To overcome this, the pre-ox yarns are woven at this state as they are more handleable and then the woven fabric is subjected to further heat treatment in very precisely controlled industrial processes specifically designed for this purpose to convert the pre-ox to carbon fiber. During this heat treatment, conversion process step, the pre-ox yarns undergo linear, volumetric and mass changes all of which affect the way in which the initial fiber plying and twisting provides handling strength to the yarns. The handling strength of the yarn is diminished. The fabric used in the applications cited is typically a warp knit construction. The expansion capability of the fabric required is likely gained from two sources, one from the ability of the knit construction to stretch and two, the actual pulling apart of the spun yarns since the heat treatment has reduced the dry yarn load carrying capability. This second mechanism is undesirable as the load carrying capability of the yarn and therefore the fabric is greatly reduced.

Therefore, a need exists for an improved reinforcing fabric configured for use in intumescent materials on structures, like bridge structural elements, exposed pipe in an oil refinery, or the like, that are configured to change shape or dimensions in a controlled, predictable way when subjected to elevated temperature and mechanical loads from the expanding intumescent material.

The instant disclosure of a heat activated reinforcing fabric may be designed to address at least certain aspects of the problems discussed above.

### SUMMARY

The present disclosure solves the aforementioned limitations of the currently available reinforcing fabrics configured for use on structures which require intumescent material for protection from fire and extreme heat, like bridge structural elements or exposed pipe in an oil refinery, by providing a reinforcing fabric configured for intumescent material expansion. The disclosed reinforcing fabric may include a woven fabric with a plurality of composite yarns. Each composite yarn may include a fire resistant component and a crimping component. The crimping component may be bonded to the fire resistant component, where the fire resistant component may be in a crimped state and the crimping component may be in a relaxed state when bonded. The woven fabric may be woven with the plurality of the composite yarns with the fire resistant component maintained in the crimped state and the crimping component maintained in the relaxed state in each of the composite yarns. When the woven fabric is imbedded in an intumescent material, the woven fabric may be configured to reinforce the intumescent material during heat expansion, and mechanical loads from the expanding intumescent material, in a controlled and predictable manner.

One feature of the disclosed reinforcing fabric may be that when the woven fabric is imbedded in the intumescent material and is subjected to heat where the intumescent material expands, forces of the intumescent material expansion act on the composite yarns, where the crimping component of each composite yarn may be configured to expand or soften thereby straightening the crimp of the fire resistant component.

Another feature of the disclosed reinforcing fabric may be that when the woven fabric is imbedded in the intumescent material and reaches a decomposition point or a melt point of the crimping component, the crimping component may be configured to fully release the crimp of the fire resistant component to fully extend, where the fire resistant component may be configured to carry the full load of the expanding intumescent material while remaining imbedded therein.

In select embodiments of the disclosed reinforcing fabric, the fire resistant component may be in a sinusoidal shape in the crimped state.

Another feature of the disclosed reinforcing fabric may be that the crimped state of the fire resistant component may be configured to have a tailored crimp based on a desired use of the intumescent material.

In select embodiments of the disclosed reinforcing fabric, the crimping component may be a stretchy fiber. In these stretchy fiber embodiments of the reinforcing fabric, each composite yarn may be made by various means or methods with a stretchy fiber. In select embodiments using the stretchy fiber as the crimping component, each composite yarn may be manufactured by stretching the stretchy fiber and bonding the fire resistant component to the stretched stretchy fiber. Whereby, when the stretchy fiber is relaxed to the relaxed state, the fire resistant component may be crimped to the crimped state. In other select embodiments using the stretchy fiber as the crimping component, each composite yarn may be manufactured by overwrapping the stretchy fiber with the fire resistant component. In this embodiment, the fire resistant component may take an S-form with the stretchy fiber in a relatively straight state and the fire resistant component may be in an S-configuration. Wherein, dimensions of the S-form may be configured to be modified by altering a relative tension of the stretchy fiber and the fire resistant component. In addition, a frequency of cross-overs of the stretchy fiber may be configured to be adjusted to increase or decrease a difference in length between an s-length of the fire resistant component and a straight length of the stretchy fiber. In other select embodiments using the stretchy fiber as the crimping component, each composite yarn may be manufactured by braiding the stretchy fiber with the fire resistant component. In these embodiments, the stretchy fiber may be braided in a stretched state with a constant tension applied for a desired amount of stretch for each composite yarn. Once braided, the stretchy fiber may be relaxed where it may contract and cause the fire resistant component to crimp and form the S-configuration;

In select embodiments of the disclosed reinforcing fabric, the crimping component may be a melt-able yarn. In these melt-able yarn embodiments of the reinforcing fabric, each composite yarn may be made by various means or methods with the melt-able yarn. In select embodiments, each composite yarn may be produced by lining the melt-able yarn along the fire resistant component, heating the lined melt-able yarn, running the lined melt-able yarn and fire resistant component between two partially meshed gears where they are crimped and cooling the crimped melt-able yarn and fire resistant component, resulting in a crenulated or crimped composite yarn that is maintained in the crimped state by the solidified melt-able yarn.

In select embodiments of the disclosed reinforcing fabric, the crimping component may be a thermoplastic coating. In these thermoplastic coating embodiments of the reinforcing fabric, each composite yarn may be made by various means or methods with the thermoplastic coating. In select embodiments, each composite yarn may be produced by coating the thermoplastic coating on the fire resistant component, heating the coated fire resistant component, running the coated fire resistant component between two partially meshed gears where they are crimped, and cooling the crimped coated fire resistant component, resulting in a crenulated or crimped composite yarn that is maintained in the crimped state by the solidified thermoplastic coating.

In various other select embodiments of the disclosed reinforcing fabric, the crimping component may be any various combinations of the stretchy fiber, melt-able yarn and/or thermoplastic coating embodiments as shown and/or described herein.

In select embodiments of the disclosed reinforcing fabric, the woven fabric may include an open mesh, leno weave. The composite yarns in the open mesh, leno weave of these embodiments of the woven fabric may include a plurality of warp yarns and a plurality of weft yarns. As such, a mesh size of the woven fabric can be configured by selecting the number of composite yarns per inch for the plurality of warp yarns and the plurality of weft yarns. Wherein, the woven fabric may be woven in the open mesh, leno weave where the fire resistant component is maintained in the crimped state and the stretchy fiber is in the relaxed state for each of the plurality of warp yarns and the plurality of weft yarns. And when the woven fabric may be imbedded in the intumescent material and is subjected to heat where the intumescent material expands, the stretchy fiber in each warp yarn and each weft yarn of the woven fabric may be configured to expand in both a warp direction and a weft direction from the forces of the intumescent material expansion acting on the woven fabric, thereby increasing the mesh size of the woven fabric. In select example embodiments, but clearly not limited thereto, the mesh size of the woven fabric may be approximately ¼ inch opening between adjacent warp yarns and adjacent weft yarns.

In select embodiments of the disclosed reinforcing fabric, the fire resistant component may be made from a fire resistant material. In select possibly preferred embodiments, the fire resistant material of the fire resistant component may be, but is not limited thereto, carbon or fiberglass. In select possibly most preferred embodiments, the fire resistant component may be a fully carbonized carbon filament fiber. In select embodiments, the fire resistant component, like the fully carbonized carbon filament fiber, but not limited thereto, may have a useful temperature of between 1000 degrees Fahrenheit and 3000 degrees Fahrenheit.

In select embodiments of the disclosed reinforcing fabric, the crimping component may be a synthetic fiber or coating. In select embodiments, the synthetic fiber or coating may have an elasticity configured to stretch up to five times its length. In other select embodiments, the synthetic fiber may be, but is not limited to, a polyether-polyurea copolymer fiber, a specially formulated polyester, or a specially formulated nylon. The polyether-polyurea copolymer fiber may be a spandex fiber or an elastane fiber, yarn or coating.

One feature of the disclosed reinforcing fabric may be that the crimping component may not be made from a second fire resistant material and/or may have a melting temperature of between 200 degrees Fahrenheit and 400 degrees Fahrenheit.

In another aspect, the instant disclosure embraces the composite yarn for the disclosed reinforcing fabric configured for intumescent material expansion. In sum, the composite yarn for the disclosed reinforcing fabric may include any of the various embodiments or combination of embodiments shown and/or described herein. In general, the composite yarn for the disclosed reinforcing fabric may include the fire resistant component and the crimping component. The crimping component may be bonded to the fire resistant component. The fire resistant component may be in a crimped state and the crimping component may be in a relaxed state when bonded. The composite yarn may be configured to be woven into the reinforcing fabric with the fire resistant component maintained in the crimped state and the crimping component maintained in the relaxed state.

In select embodiments of the disclosed composite yarn for the reinforcing fabric disclosed herein, the fire resistant component may be in a sinusoidal shape in the crimped state. One feature of the disclosed composite yarn may be that the crimped state of the fire resistant component can be configured to have a tailored crimp based ono a desired use of the intumescent material.

In select embodiments of the disclosed composite yarn for the reinforcing fabric disclosed herein, the crimping component may be a stretchy fiber. In these stretchy fiber embodiments of the composite yarn, the composite yarn may be made by various means or methods with the stretchy fiber. In select embodiments using the stretchy fiber as the crimping component, the disclosed composite yarn may be manufactured by stretching the stretchy fiber and bonding the fire resistant component to the stretched stretchy fiber. Whereby, when the stretchy fiber is relaxed to the relaxed state, the fire resistant component may be crimped to the crimped state. In other select embodiments using the stretchy fiber as the crimping component, the disclosed composite yarn may be manufactured by overwrapping the stretchy fiber with the fire resistant component. In this embodiment, the fire resistant component may take an S-form with the stretchy fiber in a relatively straight state and the fire resistant component may be in an S-configuration. Wherein, dimensions of the S-form may be configured to be modified by altering a relative tension of the stretchy fiber and the fire resistant component. In addition, a frequency of cross-overs of the stretchy fiber may be configured to be adjusted to increase or decrease a difference in length between an s-length of the fire resistant component and a straight length of the stretchy fiber. In other select embodiments using the stretchy fiber as the crimping component, the disclosed composite yarn may be manufactured by braiding the stretchy fiber with the fire resistant component. In these embodiments, the stretchy fiber may be braided in a stretched state with a constant tension applied for a desired amount of stretch for the composite yarn. Once braided, the stretchy fiber may be relaxed where it may contract and cause the fire resistant component to crimp and form the S-configuration;

In select embodiments of the disclosed composite yarn for the reinforcing fabric disclosed herein, the crimping component may be a melt-able yarn. In these melt-able yarn embodiments of the composite yarn, the composite yarn may be made by various means or methods with the melt-able yarn. In select embodiments, the composite yarn may be produced by lining the melt-able yarn along the fire resistant component, heating the lined melt-able yarn, running the lined melt-able yarn and fire resistant component between two partially meshed gears where they are crimped and cooling the crimped melt-able yarn and fire resistant component, resulting in a crenulated or crimped composite yarn that is maintained in the crimped state by the solidified melt-able yarn.

In select embodiments of the disclosed composite yarn for the reinforcing fabric disclosed herein, the crimping component may be a thermoplastic coating. In these thermoplastic coating embodiments of the composite yarn, the composite yarn may be made by various means or methods with the thermoplastic coating. In select embodiments, the composite yarn may be produced by coating the thermoplastic coating on the fire resistant component, heating the coated fire resistant component, running the coated fire resistant component between two partially meshed gears where they are crimped, and cooling the crimped coated fire resistant component, resulting in a crenulated or crimped composite yarn that is maintained in the crimped state by the solidified thermoplastic coating.

In various other select embodiments of the disclosed composite yarn for the reinforcing fabric disclosed herein, the crimping component may be any various combinations of the stretchy fiber, melt-able yarn and/or thermoplastic coating embodiments as shown and/or described herein.

In select embodiments of the disclosed composite yarn for the reinforcing fabric disclosed herein, the fire resistant component may be made from a fire resistant material. In select possibly preferred embodiments of the composite yarn, the fire resistant material of the fire resistant component may include, but is not limited thereto, carbon or fiberglass. In select possibly most preferred embodiments of the composite yarn, the fire resistant component may be a fully carbonized carbon filament fiber. In select embodiments of the composite yarn, the fire resistant component, like the fully carbonized carbon filament fiber, but not limited thereto, may have a useful temperature of between 1000 degrees Fahrenheit and 3000 degrees Fahrenheit.

In select embodiments of the disclosed composite yarn for the reinforcing fabric disclosed herein, the crimping component may be a synthetic fiber or coating. In select embodiments of the composite yarn, the synthetic fiber or coating may have an elasticity configured to stretch up to five times its length. In other select embodiments of the composite yarn, the synthetic fiber may be, but is not limited to, a polyether-polyurea copolymer fiber, a specially formulated polyester, or a specially formulated nylon. The polyether-polyurea copolymer fiber may be a spandex fiber or an elastane fiber, yarn or coating.

One feature of the disclosed composite yarn for the reinforcing fabric disclosed herein may be that the crimping component may not be made from a second fire resistant material and/or may have a melting temperature of between 200 degrees Fahrenheit and 400 degrees Fahrenheit.

In another aspect, the instant disclosure embraces a reinforced intumescent coating for a structure. In sum, the reinforced intumescent coating may include the disclosed reinforcing fabric and composite yarns therein in any of the various embodiments and/or combinations of embodiments described and/or shown herein. As such, the reinforced intumescent coating for the structure may generally include a woven fabric which may include a plurality of composite yarns, where each composite yarn may include the fire resistant component and the crimping component. The crimping component may be bonded to the fire resistant component, where the fire resistant component may be in a crimped state and the crimping component may be in a relaxed state when bonded. The woven fabric may be woven with each of the composite yarns with the fire resistant component maintained in the crimped state and the crimping component maintained in the relaxed state. In addition to the woven fabric, the reinforced intumescent material may include an intumescent material or coating. The woven fabric may be imbedded in the intumescent material. When the woven fabric is imbedded in the intumescent material, the woven fabric may be configured to reinforce the intumescent material during heat expansion, and mechanical loads from the expanding intumescent material, in a controlled and predictable manner. In addition, when the reinforced intumescent material is applied to the structure, the reinforced intumescent material may be configured to protect the structure from fire and extreme heat.

In select embodiments of the disclosed reinforced intumescent coating for the structure, when the woven fabric imbedded in the intumescent material is subjected to heat where the intumescent material expands and forces of the intumescent material expansion act on the composite yarns, the crimping component of each composite yarn may be configured to expand or soften thereby straightening the crimp of the fire resistant component.

In select embodiments of the disclosed reinforced intumescent coating for the structure, when the woven fabric is imbedded in the intumescent material and reaches a decomposition point or a melt point of the crimping component, the crimping component may be configured to fully release the crimp of the fire resistant component to fully extend where it is configured to carry the full load of the expanding intumescent material while remaining imbedded therein.

In select embodiments of the disclosed reinforced intumescent coating for the structure, as an example and clearly not limited thereto, the fire resistant component may be a fully carbonized carbon filament fiber with a useful temperature of between 1000 degrees Fahrenheit and 3000 degrees Fahrenheit, and the crimping component may not be made from a second fire resistant material and may have a melting temperature of between 200 degrees Fahrenheit and 400 degrees Fahrenheit. Whereby, the reinforced intumescent material may be configured to protect the structure from fire and extreme heat of temperatures of approximately 1100 degrees Fahrenheit.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

The present disclosure will be better understood by reading the Detailed Description with reference to the accompanying drawings, which are not necessarily drawn to scale, and in which like reference numerals denote similar structure and refer to like elements throughout, and in which:

FIG. 1 is a perspective view of an I-beam structure with an intumescent coating with a reinforced fabric embedded therein according to select embodiments of the instant disclosure;

FIG. 2 is a perspective view of another I-beam structure with an intumescent coating with a reinforced fabric embedded therein according to select embodiments of the instant disclosure;

FIG. 3 is a perspective view of another I-beam structure with an intumescent coating with a reinforced fabric embedded therein according to select embodiments of the instant disclosure;

FIG. 4 is a perspective view of another I-beam structure with an intumescent coating with a reinforced fabric embedded therein according to select embodiments of the instant disclosure with a piece of the intumescent coating broken away to show the reinforced fabric embedded underneath;

FIG. 5 is a perspective view of another I-beam structure with an intumescent coating with a reinforced fabric embedded therein according to select embodiments of the instant disclosure with a piece of the intumescent coating broken away to show the reinforced fabric embedded underneath;

FIG. 6 is a perspective view of another I-beam structure with an intumescent coating with a reinforced fabric embedded therein according to select embodiments of the instant disclosure with a piece of the intumescent coating broken away to show the reinforced fabric embedded underneath;

FIG. 7 is a perspective view of another I-beam structure with an intumescent coating with a reinforced fabric embedded therein according to select embodiments of the instant disclosure;

FIG. 8 is a schematic view of the composite yarn for the reinforced fabric according to select embodiments of the instant disclosure;

FIG. 9 is an environmental perspective view of another I-beam structure with an intumescent coating with a reinforced fabric embedded therein according to select embodiments of the instant disclosure showing heat applied and the expansion forces of the intumescent coating resulting therefrom;

FIG. 10A is a cross-sectional of a structure with an intumescent coating with a reinforced fabric embedded therein according to select embodiments of the instant disclosure showing heat applied and the expansion forces of the intumescent coating resulting therefrom;

FIG. 10B is another cross-sectional of the structure with an intumescent coating with a reinforced fabric embedded therein from FIG. 10A showing heat applied and the expansion forces of the intumescent coating resulting therefrom where the crimping component is at a decomposition point or a melt point and the fire resistant component is carrying the full load; and

FIG. 11 is an environmental perspective view of a bridge structural elements with structures with an intumescent coating with a reinforced fabric embedded therein according to select embodiments of the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

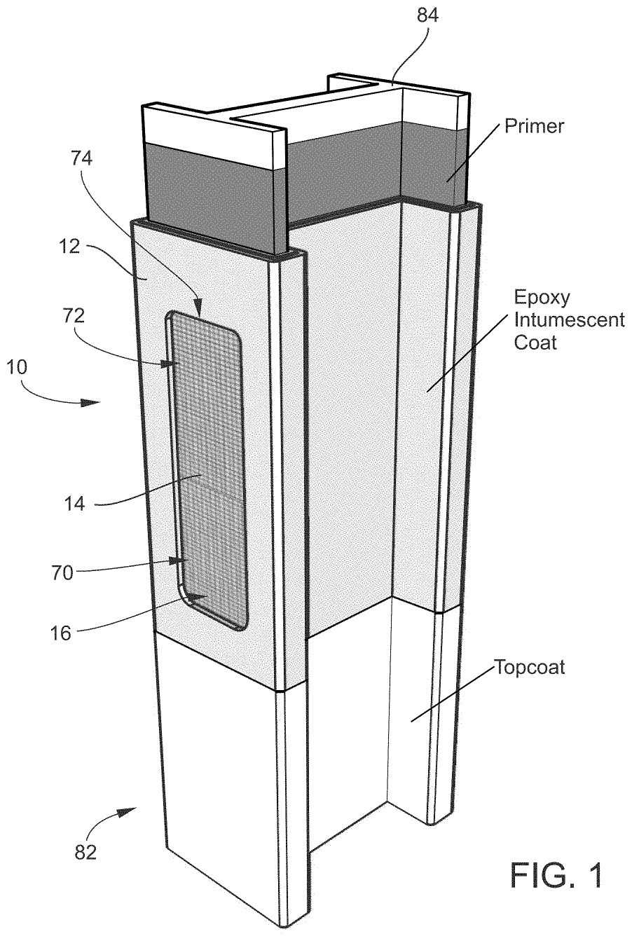

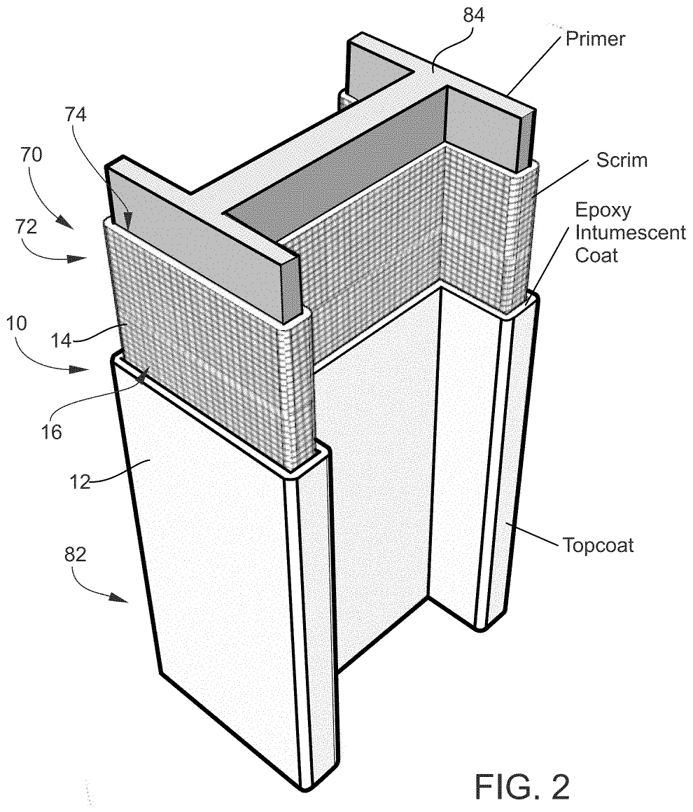

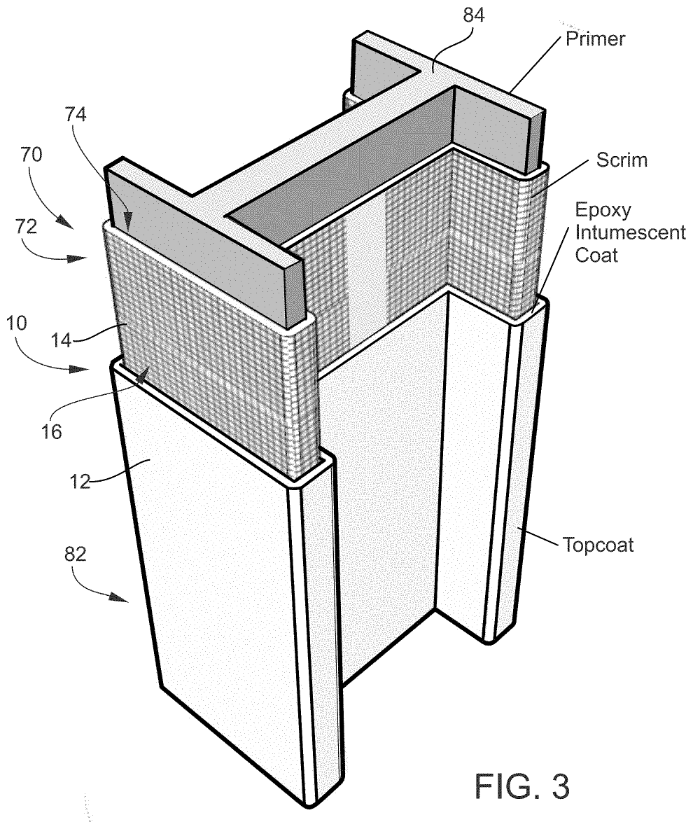

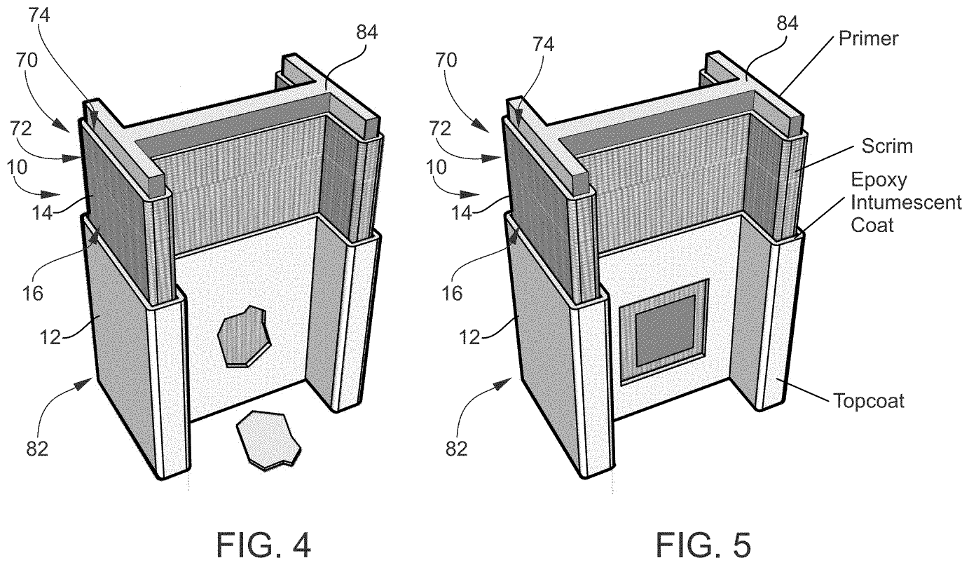

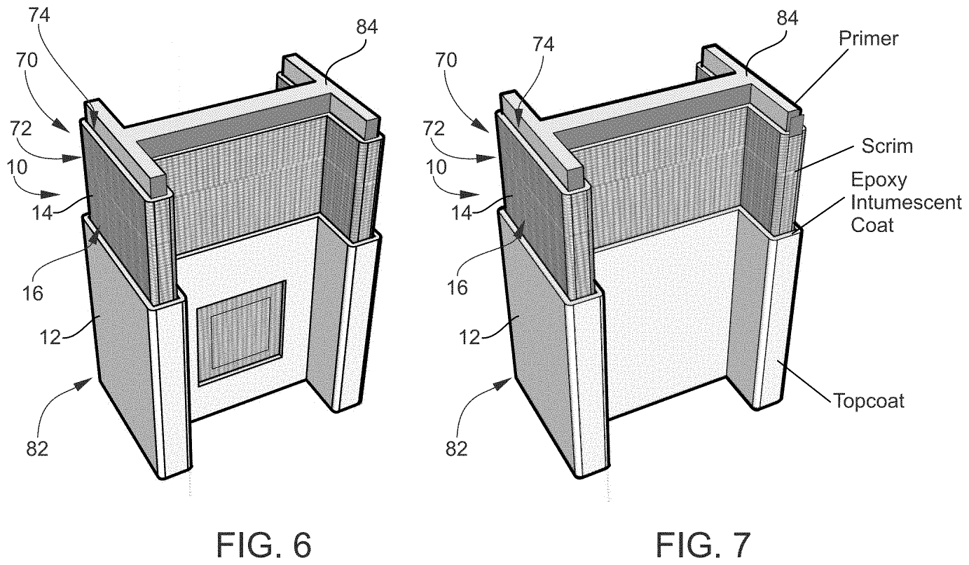

Referring now to FIGS. 1-11, in describing the exemplary embodiments of the present disclosure, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples and are merely examples among other possible examples.

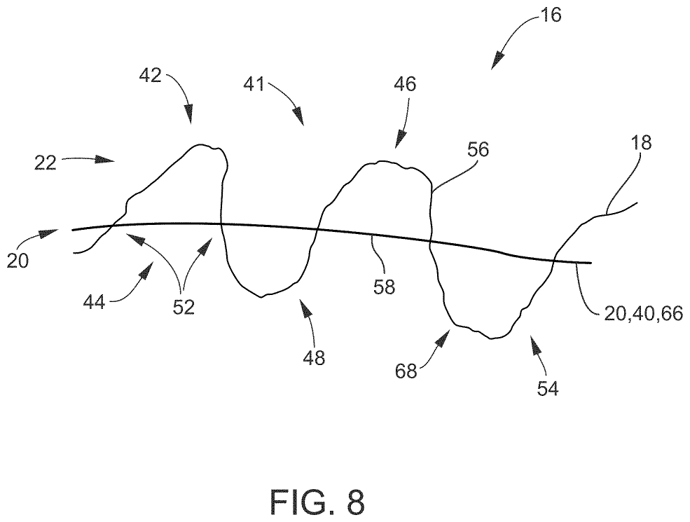

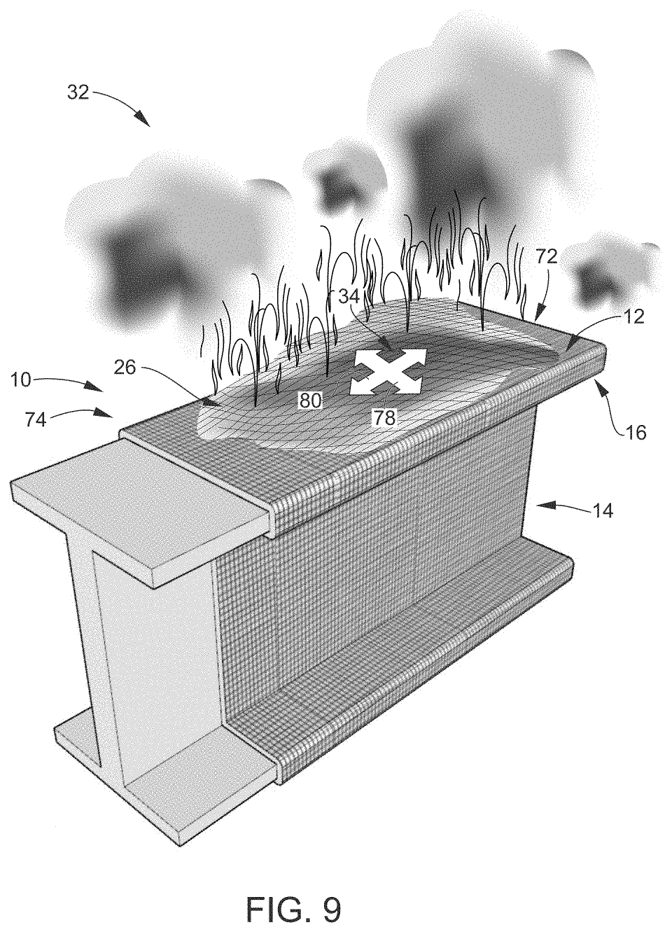

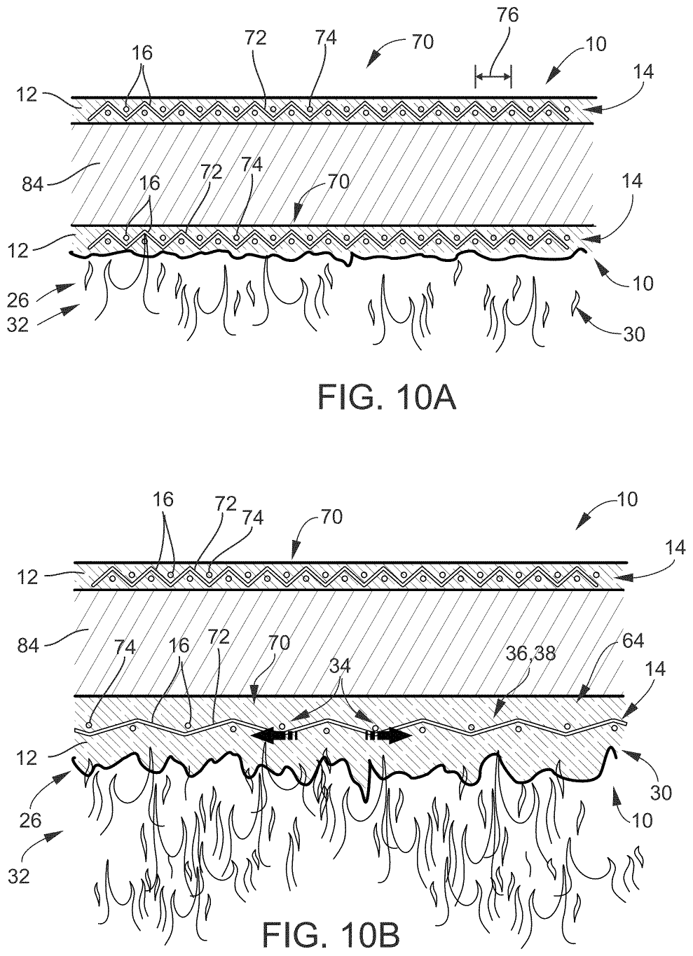

Referring now to FIGS. 1-11, in a possibly preferred embodiment, the present disclosure overcomes the above-mentioned disadvantages and meets the recognized need for such an apparatus or method by providing of the disclosed heat activated reinforcing fabric 10. The present disclosure solves the aforementioned limitations of the currently available reinforcing fabrics configured for use on structures which require intumescent material for protection from fire and extreme heat, like bridge structural elements or exposed pipe in an oil refinery, by providing reinforcing fabric 10 configured for the expansion of intumescent material 12, or the like. Reinforcing fabric 10 may generally include woven fabric 14 with plurality of composite yarns 16. Each composite yarn 16 may include fire resistant component 18 and crimping component 20. Crimping component 20 may be bonded to fire resistant component 28, where fire resistant component 18 may be in crimped state 22 and crimping component 20 may be in relaxed state 24 when bonded. See FIG. 8 as an example. Woven fabric 14 may be woven with the plurality of composite yarns 16 with fire resistant component 18 maintained in crimped state 22 and crimping component 20 maintained in relaxed state 24 in each of composite yarns 16. When woven fabric 14 is imbedded in intumescent material 12, as shown in FIGS. 1-7 and 9-11, woven fabric 14 may be configured to reinforce intumescent material 12 during heat expansion 26, and mechanical loads from the expanding intumescent material 12, in a controlled and predictable manner 30, as best shown in FIGS. 9, 10A and 10B.

Referring specifically to FIGS. 10A and 10B, one feature of reinforcing fabric 10 may be that when woven fabric 14 is imbedded in intumescent material 12 and is subjected to heat 32 where intumescent material 12 expands, forces 34 of the intumescent material expansion act on composite yarns 16, where crimping component 20 of each composite yarn may be configured to expand or soften thereby straightening the crimp of fire resistant component 18. When woven fabric 14 is imbedded in intumescent material 12 and reaches decomposition point 36 or melt point 38 of crimping component 20, crimping component 20 may be configured to fully release the crimp of fire resistant component 18 to fully extend. At this full release point of crimping component 20, fire resistant component 18 may be configured to carry the full load of the expanding intumescent material 12 while remaining imbedded therein, as best shown in FIG. 10A.

Referring now to FIG. 8, in select embodiments of reinforcing fabric 10, fire resistant component 18 may be in sinusoidal shape 41 in crimped state 22, which may also be referred to herein as S-form 42 or S-configuration 46. Accordingly, crimped state 22 of fire resistant component 18 may be configured to have a tailored crimp based on a desired use of intumescent material 12. In other words, the size and frequency of sinusoidal shape 41, S-form 42, or S-configuration 46 may be altered for providing more or less elasticity or stretching of each composite yarn 16 in woven fabric 14 for providing more or less expansion support for intumescent material 12.

Crimping component 20 of each composite yarn 16 in woven fabric 14 of reinforcing fabric 10 may be any material, yarn, fiber, coating, the like, etc. configured to hold fire resistant component 18 in crimped state 22 under no heat expansion or mechanical load from intumescent material 12, while also gradually releasing crimped state 22 when subjected to heat expansion and mechanical loads from the expanding intumescent material 12. As an example, in select embodiments, crimping component 20 may be stretchy fiber 40. In these stretchy fiber 40 embodiments of reinforcing fabric 10, each composite yarn 16 may be made by various means or methods with stretchy fiber 40. In select embodiments using stretchy fiber 40 as crimping component 20, each composite yarn 16 may be manufactured by stretching stretchy fiber 40 and bonding fire resistant component 18 to stretched stretchy fiber 40. Whereby, when stretchy fiber 40 is relaxed to the relaxed state, the fire resistant component 18 may be crimped to crimped state 22. As another example, in other select embodiments using stretchy fiber 40 as crimping component 20, each composite yarn 16 may be manufactured by overwrapping stretchy fiber 40 with fire resistant component 18. In this embodiment, fire resistant component 18 may take S-form 42 (as shown in FIG. 8) with stretchy fiber 40 in a relatively straight state 44 and fire resistant component 18 in S-configuration 46. Wherein, dimensions 48 of S-form 42 may be configured to be modified by altering a relative tension of stretchy fiber 40 and fire resistant component 18. In addition, frequency of cross-overs 52 of stretchy fiber 40 may be configured to be adjusted to increase or decrease difference 54 in length between s-length 56 of fire resistant component 18 and straight length 58 of stretchy fiber 40. As yet another example, in other select embodiments using stretchy fiber 40 as crimping component 20, each composite yarn 16 may be manufactured by braiding stretchy fiber 40 with fire resistant component 18. In these embodiments, stretchy fiber 40 may be braided in a stretched state with a constant tension applied for desired amount of stretch 64 for each composite yarn 16. Once braided, stretchy fiber 40 may be relaxed where it may contract and cause fire resistant component 18 to crimp and form the S-configuration 46 (as best shown in FIG. 8).

In other select embodiments of reinforcing fabric 10, crimping component 20 may be melt-able yarn 66. In these melt-able yarn 66 embodiments of reinforcing fabric 10, each composite yarn 16 may be made by various means or methods with melt-able yarn 66. As an example, and clearly not limited thereto, in select embodiments, each composite yarn 16 may be produced by lining melt-able yarn 66 along fire resistant component 18, heating lined melt-able yarn 66, running lined melt-able yarn 66 and fire resistant component 18 between two partially meshed gears where they are crimped, and cooling the crimped melt-able yarn 66 and fire resistant component 18, resulting in a crenulated or crimped composite yarn 16 that is maintained in crimped state 22 by the solidified melt-able yarn 66.

In other select embodiments of reinforcing fabric 10, crimping component 20 may be thermoplastic coating 68. In these thermoplastic coating 68 embodiments of reinforcing fabric 10, each composite yarn 16 may be made by various means or methods with thermoplastic coating 68. As an example, and clearly not limited thereto, in select embodiments, each composite yarn 16 may be produced by coating thermoplastic coating 68 on fire resistant component 18, heating coated fire resistant component 18, running the coated fire resistant component 18 between two partially meshed gears where they are crimped, and cooling the crimped coated fire resistant component 18, resulting in a crenulated or crimped composite yarn 16 that is maintained in crimped state 22 by the solidified thermoplastic coating 68.

In various other select embodiments of reinforcing fabric 10, crimping component 20 may be any various combinations of the embodiments described and/or shown herein, including any embodiments with stretchy fiber 40, melt-able yarn 66, and/or thermoplastic coating 68 embodiments as shown and/or described herein.

Woven fabric 14 of reinforcing fabric 10 may be any woven fabric material or the like. In select possibly preferred embodiments, as shown in the figures, woven fabric 14 may include open mesh, leno weave 70. Leno weave 70 (also called Gauze weave or Cross weave) is a weave in which two warp yarns 72 are twisted around the weft yarns 74 to provide a strong yet sheer fabric. The standard warp yarn 72 is paired with a skeleton or ‘doup’ yarn; these twisted warp yarns 72 gripped tightly to the weft which causes the durability of the fabric. Leno weave 70 may produce an open fabric, like a mesh, with almost no yarn slippage or misplacement of threads. As such, composite yarns 16 in open mesh, leno weave 70 of woven fabric 14 may include a plurality of warp yarns 72 (machine direction) and a plurality of weft yarns 74 (transverse direction). As such, mesh size 76 of woven fabric 14 can be configured by selecting the number of composite yarns 16 per inch for the plurality of warp yarns 72 and the plurality of weft yarns 74. Wherein, woven fabric 14 may be woven in open mesh, leno weave 70 where fire resistant component 18 is maintained in crimped state 22 and crimping component 20 is in relaxed state 24 for each of the plurality of warp yarns 72 and the plurality of weft yarns 74. And when woven fabric 14 may be imbedded in intumescent material 12, as shown in FIGS. 1-7 and 9-11, and is subjected to heat 32 (as shown in FIGS. 9-10) where intumescent material 12 expands, crimping component 20 in each warp yarn 72 and each weft yarn 74 of woven fabric 14 may be configured to expand in both warp direction 78 and weft direction 80 from forces 34 of intumescent material expansion acting on woven fabric 14, thereby increasing mesh size 76 of woven fabric 14. In select example embodiments, but clearly not limited thereto, mesh size 76 of woven fabric 14 may be approximately ¼ inch opening between adjacent warp yarns 72 and adjacent weft yarns 74, thereby providing an open mesh.

Fire resistant component 18 may be made from any fire resistant material. In select possibly preferred embodiments, the fire resistant component 18 may be a filament fiber, or continuous filament component. This filament fiber or continuous filament embodiment of fire resistant component 18 may add strength to reinforcing fabric 10. The fire resistance component 18 may be made from any fire resistant material. The fire resistant material 18 of fire resistant component 18 may be, but is not limited thereto, carbon or fiberglass. In select possibly most preferred embodiments, fire resistant component 19 may be a fully carbonized carbon filament fiber. In select embodiments, fire resistant component 18, may be, but is not limited thereto, having a useful temperature of between 1000 degrees Fahrenheit and 3000 degrees Fahrenheit, like the fully carbonized carbon filament fiber.

Crimping component 20 may be any synthetic fiber, yarn or coating. In select embodiments, the synthetic fiber, yarn or coating of crimping component 20 may have an elasticity configured to stretch up to five times its length. In other select embodiments, the synthetic fiber, yarn or coating may be, but is not limited to, a polyether-polyurea copolymer fiber, a specially formulated polyester, or a specially formulated nylon. The polyether-polyurea copolymer fiber may be a spandex fiber or an elastane fiber, yarn or coating. One feature of reinforcing fabric 10 may be that crimping component 20 may not be made from a second fire resistant material and/or may have a melting temperature of between 200 degrees Fahrenheit and 400 degrees Fahrenheit.

Referring specifically to FIG. 8, in another aspect, the instant disclosure embraces composite yarn 16 for use in the disclosed reinforcing fabric 10 configured for intumescent material expansion. In sum, composite yarn 16 for the disclosed reinforcing fabric 10 may include any of the various embodiments or combination of embodiments shown and/or described herein.

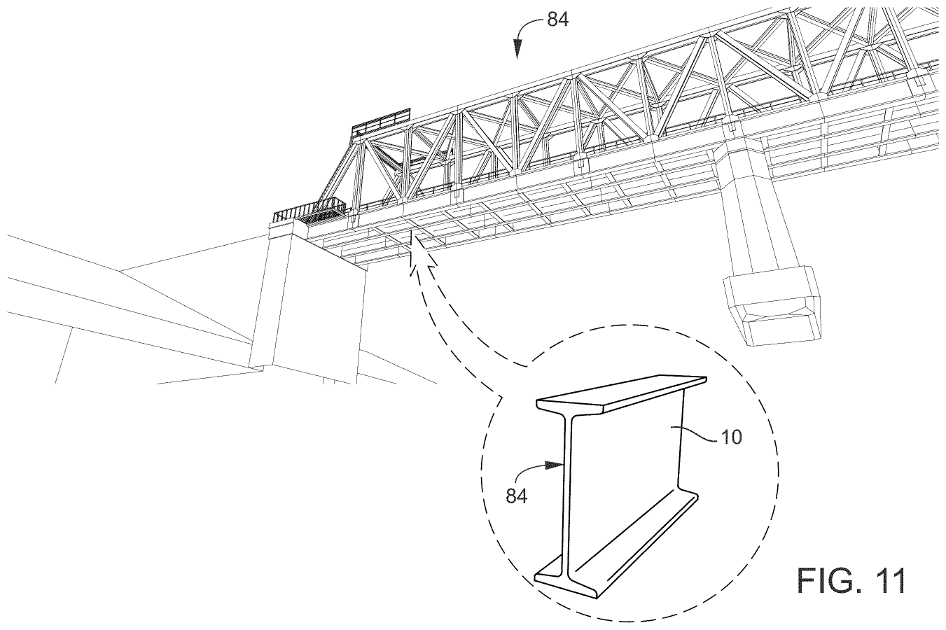

Referring now specifically to FIGS. 1-7 and 9-11, in another aspect, the instant disclosure embraces reinforced intumescent coating 82 for structure 84. In sum, reinforced intumescent coating 82 may include the disclosed reinforcing fabric 10 and composite yarns 16 therein in any of the various embodiments and/or combinations of embodiments described and/or shown herein. In addition, reinforced intumescent coating may include any other materials common or known in the relative applications, or later discovered, including any primers, epoxy intumescent coats, topcoats, the like, and any various combinations thereof, like as shown in FIGS. 1-7. In addition, reinforced intumescent coating 82 for structure 84 may also include woven fabric 14, as disclosed herein, which may include plurality of composite yarns 16. Each composite yarn 16 may include fire resistant component 18 and crimping component 20. Crimping component 20 may be bonded to fire resistant component 18, where fire resistant component 18 may be in crimped state 22 and crimping component 20 may be in relaxed state 24 when bonded, as shown in FIG. 8. Woven fabric 14 may be woven with each composite yarn 16 with fire resistant component 18 maintained in crimped state 22 and crimping component 20 maintained in relaxed state 24. In addition to woven fabric 14, reinforced intumescent material 82 may include intumescent material 12 or coating. Woven fabric 14 may be imbedded in intumescent material 12. When woven fabric 14 is imbedded in intumescent material 12, woven fabric 14 may be configured to reinforce intumescent material 12 during heat expansion 26 and mechanical loads from the expanding intumescent material 12 in controlled and predictable manner 30. As an example, when a fire starts, intumescent material 12 may expand where it may be possible that yarns 16 will see mechanical loads due to expanding intumescent material 12 before the heat from the fire has penetrated enough to heat yarns 16. In addition, when reinforced intumescent material 82 is applied to structure 84, reinforced intumescent material 82 may be configured to protect structure 84 from fire and extreme heat. Structure 84 may be any structure, like a metal structure or the like, requiring reinforced intumescent material 82 for protection from fire and extreme heat. As an example, as shown in FIGS. 1-7 and 9-10, structure 84 may be an I-beam structure or the like. As shown in FIG. 11, structure 84 may be an I-beam structure or the like used in a bridge structural elements. In another example embodiment, structure 84 may also be an exposed pipe in an oil refinery or the like. In yet another example embodiment, structure 84 may be structural supports in buildings, tall buildings, or the like. In select embodiments of reinforced intumescent coating 82 for structure 84, when woven fabric 14 imbedded in intumescent material 12 is subjected to heat 32, as best shown in FIGS. 9 and 10, where intumescent material 12 expands and forces 34 of the intumescent material expansion act on composite yarns 16, crimping component 20 of each composite yarn 16 may be configured to expand or soften thereby straightening the crimp of fire resistant component 18. In select embodiments of the disclosed reinforced intumescent coating 82 for structure 84, when woven fabric 14 is imbedded in intumescent material 12 and reaches decomposition point 36 or melt point 38 of crimping component 20, crimping component 20 may be configured to fully release the crimp of fire resistant component 18 to fully extend where fire resistant component 18 may be configured to carry the full load of the expanding intumescent material 12 while remaining imbedded therein. In select embodiments of the disclosed reinforced intumescent coating 82 for structure 84, as an example and clearly not limited thereto, fire resistant component 18 may be a fully carbonized carbon filament fiber with a useful temperature of between 1000 degrees Fahrenheit and 3000 degrees Fahrenheit, and crimping component 20 may not be made from a second fire resistant material and may have a melting temperature of between 200 degrees Fahrenheit and 400 degrees Fahrenheit. Whereby, reinforced intumescent material 82 may be configured to protect structure 84 from fire and extreme heat of temperatures of approximately 1100 degrees Fahrenheit.

In sum, the technology disclosed herein of reinforcing fabric 10, composite yarns 16 and reinforced intumescent material 12 may provide an improvement over current technology for this application. In select embodiments, the disclosed reinforcing fabric 10, composite yarns 16 and reinforced intumescent material 12 may include carbonized carbon composite yarns 16 that have continuous filaments for fire resistant component 18. This negates the need to heat treat a pre-ox version of the fiber. It also provides significantly better strength than a carbon yarn with short, staple length fibers. The disclosed composite yarn 16 with continuous fire resistant filament fibers for fire resistant component 18, however, has very low elongation. The key to allowing this composite yarn technology to be useful therefore is to create open mesh fabric 14 that can expand to accommodate the growth in coating thickness due to the expansion of intumescent material 12. This may be accomplished by developing novelty composite yarn 16 through one of several techniques that are based on using continuous filament carbon yarns. Some of the example embodiments are explained in greater detail below.

### Example 1—“S” Shaped Composite Yarn 16

An S-shaped composite yarn 16 is produced by braiding or otherwise overwrapping crimping component 20 of a synthetic yarn such as nylon or polyester around a continuous carbon filament as fire resistant component 18. If only two carriers of an eight carrier or sixteen carrier braider are used for the synthetic yarn or crimping component 20, with the carbon filament 18 as the central core, the resulting braided structure is one where the carbon core filament 18 takes the form of an “S”. See FIG. 8. The dimensions of the “S” can be modified by altering the relative tension of the synthetic carrier yarns and the carbon core filament. Ideally, the synthetic yarns (crimping component 20) are relatively straight and the carbon core filament of fire resistant component 18 is in an “S” configuration. The frequency of the synthetic yarn cross-overs can also be adjusted to increase or decrease the difference in length between the “S” length and the straight synthetic yarn length, i.e. the percent crimp. This will determine the amount of “stretch” in reinforcing fabric 10. Reinforcing fabric 10 woven with this composite yarn 16 in both warp and weft directions will “stretch” in both directions under either or both of two loading conditions. First, if reinforcing fabric 10 is subjected to temperatures where the synthetic yarn (crimping component 20) softens or melts but below the temperature limit for carbon, the “S” shaped filament of fire resistant component 18 will be allowed to straighten under load and therefore provide apparent stretch to reinforcing fabric 10. The second mechanism that will allow fabric 10 growth is if reinforcing fabric 10 is subjected to mechanical loads where stretch is imparted to the synthetic yarn (crimping component 20) even absent heat but insufficient load to cause any elongation in carbon filament as fire resistant component 18. For example, when a fire starts, intumescent material 12 may expands where it may be possible that yarns 16 will see mechanical loads due to expanding intumescent material 12 before the heat from the fire has penetrated enough to heat yarns 16. It should be noted that a variety of synthetic yarns are available where the softening or melting temperature can be selected and also the elongation at varying mechanical loading conditions. Many of the synthetic yarns of interest have softening temperatures (200-400 degrees F.) well below the expected temperature for the applications (1100 degrees F.) and the useful temperature for carbon yarn (1000-3000 F).

### Example 2—“S” Shaped Composite Yarn 16 with Stretchy Yarn 40

The S shaped composite yarn 16 described above can also be fabricated using a stretchy yarn 40 in the synthetic yarn (composite component 20) location on the braider. Examples of stretchy yarns 40 can include spandex, specially formulated polyester and specially formulated nylon. In this instance, the stretchy yarn 40 is placed on the two carriers of the braider with the carbon core filament as the fire resistant component 18. The stretchy yarn 40 has a constant tension applied as the braiding is conducted. This tension applies a desired amount of stretch to the novelty composite yarn 16 produced. As the novelty composite yarn 16 is taken up on a separate spool, the tension in the stretchy yarn 40 is relaxed and the length contracts. This contraction causes the “S” curvature to be formed. The degree of crimp can be controlled by stretchy yarn 40 selection, the level of tension and therefore stretch imparted to the composite yarn 16 during braiding and the rate at which the braid is formed (plaits per inch).

### Example 3—Crenulated Composite Yarn 16 with Melt-Able Yarn 66

A composite yarn 16 is produced where melt-able yarn 66, such as a hot melt yarn as used in the carbon textile industry, is added to a carbon yarn as the fire resistant component 18, such that the hot melt or melt-able yarn 66 and the carbon filament, as the fire resistant component 18, are essentially in parallel with each other. The two component yarn 16 is run between two partially meshed gears where the yarn pair is crimped. Heat is applied to the composite yarn 16 before entering the meshed gears and the yarn pair is cooled on the exit side of the gears. The result is a crenulated or crimped composite yarn 16 that is maintained in the crimped condition by the solidified hot melt of melt-able yarn 66. The composite yarn 16 in this form is weave-able in both the warp direction 78 and weft direction 80 of reinforcing fabric 10. As in the case above, the elongation in the composite yarn 16 and therefore in the fabric 10 can be realized as the two component composite yarn 16 is exposed to heat where the hot melt of melt-able yarn 66 is softened or melted. The amount of stretch that can be imparted to the fabric 10 can be tailored by changing the amplitude and frequency of the waviness introduced into the composite yarn 16. The chemistry of the hot melt of melt-able yarn 66 can also be tailored to select the temperature and or the mechanical load at which the crimped composite yarn 16 can be straightened.

### Example 4—Crenulated Composite Yarn 16 with Thermoplastic Coating 68

A composite yarn 16 is produced with a carbon fire resistant filament as the fire resistant component 18 and thermoplastic coating 68. The coated composite yarn 16 is passed through a device such as semi meshed gears described above. The coated composite yarn 16 is heated on the inlet side of the meshed gears and cooled on the outlet side of the meshed gears. The resulting composite yarn 16 is one that has crimp formed into the composite yarn 16. The amount of crimp, which is defined as the difference between the length of the composite yarn 16 as crimped and the length of the composite yarn 16 where the crimp has been straightened. The amount of crimp can be adjusted by the dimensions of the semi meshed gears. The crimped composite yarn 16 is stable enough to be woven into both the warp direction 78 and weft direction 80 of reinforcing fabric 10. The type of thermoplastic can be selected to determine at what temperature or mechanical load the crimped composite yarn 16 will be free to elongate to the point where the crimped composite yarn 16 is straightened.

In all these example cases noted above, the composite yarns 16 can be used to weave any style of fabric for reinforcing fabric 10. In the instance of the applications cited, an open mesh fabric 14 is woven to allow the other features of the fabric necessary for the successful performance to be realized.

In summary, an open mesh reinforcing fabric 10 is woven using one of the novelty composite yarns 16 types described above. The fabric design has approximately one-quarter inch openings between adjacent warp yarns 72 and weft yarns 74. The reinforcing fabric 10 is coated with the intumescent material 12 required for the specific application. The coated fabric 10 is assembled onto the structure 84 requiring thermal protection. If the structure 84 is exposed to a damaging fire, the intumescent material 12 will react and will expand through the openings in the fabric 10. This increase in thickness dimension will be allowed as the composite yarns 16 that comprise the fabric 10 will extend as the synthetic or thermoplastic component of the composite yarn 16 will soften or otherwise allow the carbon component 18 portion of the composite yarn 16 to straighten and elongate. The intumescent material 12 will continue to ablate and expose sublayers of the coating for the thermal-protection process to continue until the fire is extinguished or the coating material is depleted.

To summarize the disclosure, the technology relies on two features of reinforcing fabric 10, the composite yarn 16 from which reinforcing fabric 10 is woven and the design of the woven fabric 14. The composite yarn 16, in one manifestation, is a two component system where one part is a fire resistant component 18 material such as carbon or fiberglass and the other component is a stretchy yarn 40 (such as spandex or elastane) that is not fire resistant. The composite yarn 16 is manufactured in such a way that stretch is applied to the stretchy yarn 40 during the combination with the fire resistant filament as the fire resistant component 18 and when the combined composite yarn 16 is relaxed, the fire resistant filament is crimped for example in sinusoidal shape 41. The amount of crimp can be tailored depending on the application. The fabric design that these composite yarns 16 will be used to weave is an open mesh, leno weave 70. The mesh size 76 can be controlled by selecting the warp and weft number of yarns per inch. The reinforcing fabric 10 is woven with these composite yarns 16 in the warp direction 78 and weft direction 80 such that the crimp is maintained in the composite yarn 16 during the weaving process. The intumescent material 12 is applied to the open mesh fabric 14 and as such, the fabric 14 acts to reinforce the intumescent material. When the coated (reinforced) fabric 10 is subjected to heat, the intumescent material 12 expands. The forces 34 of intumescent material 12 expansion act on the stretchy fiber 40 and the open mesh fabric 14 expands with the intumescent material 12. The mesh size increases as a result of such expansion of the intumescent material 12. When the heat 32 reaches the melt point 38 or decomposition point 36 for the stretchy fiber 40, it fully releases the fire resistant filament to fully extend and therefore fully carry the load of the expanding intumescent material 12 while remaining imbedded in the same. Accordingly, the stretch of the disclosed reinforcing fabric 10 relies on the stretch provided by the woven composite yarns 16, not the textile design.

One advantage of the disclosed woven fabric 14 is that it can be stronger than a knit fabric since knitted fabrics are comprised of a series of interlocking loops, where the loops, when stretched to the limit, form stitches or knots which reduce the strength of the yarns used in the knitting process. The woven approach described in the disclosed reinforcing fabric 10 when stretched, result in straight yarns with higher load carrying capability.

In the specification and/or figures, typical embodiments of the disclosure have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein but is limited only by the following claims.

1. A reinforcing fabric configured for intumescent material expansion comprising:
a woven fabric comprising a plurality of composite yarns, each composite yarn including:
a fire resistant component; and
a crimping component bonded to the fire resistant component, where the fire resistant component is in a crimped state and the crimping component is in a relaxed state when bonded;
the woven fabric is woven with the plurality of composite yarns with the fire resistant component maintained in the crimped state and the crimping component maintained in the relaxed state in each of the plurality of composite yarns;
wherein, when the woven fabric is imbedded in an intumescent material, the woven fabric is configured to reinforce the intumescent material during heat expansion, and mechanical loads from the expanding intumescent material, in a controlled and predictable manner.

2. The reinforcing fabric of claim 1, wherein when the woven fabric is imbedded in the intumescent material and is subjected to heat where the intumescent material expands, forces of expansion of the intumescent material act on the composite yarns, where the crimping component of each composite yarn is configured to expand or soften thereby straightening the crimped state of the fire resistant component.

3. The reinforcing fabric of claim 1, wherein when the woven fabric is imbedded in the intumescent material and reaches a decomposition point or a melt point of the crimping component, the crimping component is configured to fully release the crimped state of the fire resistant component to fully extend, where the fire resistant component is configured to carry a full load of the intumescent material expanding while remaining imbedded therein.

4. The reinforcing fabric of claim 1, wherein the fire resistant component is in a sinusoidal shape in the crimped state.

5. The reinforcing fabric of claim 4, wherein the crimped state of the fire resistant component is configured to have a tailored crimp based on a desired use of the intumescent material.

6. The reinforcing fabric of claim 1, wherein:
the crimping component is a stretchy fiber, wherein each composite yarn is manufactured by stretching the stretchy fiber and bonding the fire resistant component to the stretched stretchy fiber, whereby, when the stretchy fiber is relaxed to the relaxed state, the fire resistant component is crimped to the crimped state;
the crimping component is the stretchy fiber, wherein each composite yarn is manufactured by overwrapping the stretchy fiber with the fire resistant component, where the fire resistant component takes an S-form with the stretchy fiber in a relatively straight state and the fire resistant component in an S-configuration, wherein:
dimensions of the S-form are configured to be modified by altering a relative tension of the stretchy fiber and the fire resistant component; and
a frequency of cross-overs of the stretchy fiber are configured to be adjusted to increase or decrease a difference in length between an s-length of the fire resistant component and a straight length of the stretchy fiber;
the crimping component is the stretchy fiber, wherein each composite yarn is manufactured by braiding the stretchy fiber with the fire resistant component, where the stretchy fiber is braided in a stretched state with a constant tension applied for a desired amount of stretch for the composite yarn, and once braided, the stretchy fiber is relaxed where it contracts and causes the fire resistant component to crimp and form the S-configuration;
the crimping component is a melt-able yarn, wherein the composite yarn is produced by lining the melt-able yarn along the fire resistant component, heating the lined melt-able yarn, running the lined melt-able yarn and fire resistant component between two partially meshed gears where they are crimped and cooling the crimped melt-able yarn and fire resistant component, resulting in a crenulated or crimped composite yarn that is maintained in the crimped state by the solidified melt-able yarn;
the crimping component is a thermoplastic coating, where the composite yarn is produced by coating the thermoplastic coating on the fire resistant component, heating the coated fire resistant component, running the coated fire resistant component between two partially meshed gears where they are crimped, and cooling the crimped coated fire resistant component, resulting in a crenulated or crimped composite yarn that is maintained in the crimped state by the solidified thermoplastic coating;
or
combinations thereof.

7. The reinforcing fabric of claim 1, wherein the woven fabric includes an open mesh, leno weave, wherein the composite yarns in the open mesh, leno weave of the woven fabric include a plurality of warp yarns and a plurality of weft yarns, where a mesh size of the woven fabric is configured by a number of composite yarns per inch for the plurality of warp yarns and the plurality of weft yarns, wherein:
the woven fabric is woven in the open mesh, leno weave where the fire resistant component is maintained in the crimped state and the crimping component is in the relaxed state for each of the plurality of warp yarns and the plurality of weft yarns; and
when the woven fabric is imbedded in the intumescent material and is subjected to heat where the intumescent material expands, the crimping component in each warp yarn and each weft yarn of the woven fabric is configured to expand in both a warp direction and a weft direction from the forces of the intumescent material expansion acting on the woven fabric, thereby increasing the mesh size of the woven fabric.

8. The reinforcing fabric of claim 7, wherein the mesh size of the woven fabric is approximately ¼ inch opening between adjacent warp yarns and adjacent weft yarns.

9. The reinforcing fabric of claim 1, wherein:
the fire resistant component is made from a fire resistant material;
the crimping component is a synthetic fiber with elasticity configured to stretch up to five times its length;
or
combinations thereof.

10. The reinforcing fabric of claim 9, wherein:
the fire resistant material of the fire resistant component includes a continuous filament;
the synthetic fiber is a polyether-polyurea copolymer fiber, a specially formulated polyester, or a specially formulated nylon, where the polyether-polyurea copolymer fiber is a spandex fiber or an elastane fiber;
or
combinations thereof.

11. The reinforcing fabric of claim 10, wherein:
the continuous filament is a fully carbonized carbon filament fiber with a useful temperature of between 1000 degrees Fahrenheit and 3000 degrees Fahrenheit;
the crimping component is not made from a second fire resistant material and has a melting temperature of between 200 degrees Fahrenheit and 400 degrees Fahrenheit;
or
combinations thereof.

12. A composite yarn for a reinforcing fabric configured for expansion of an intumescent material comprising:
a fire resistant component; and
a crimping component bonded to the fire resistant component, where the fire resistant component is in a crimped state and the crimping component is in a relaxed state when bonded;
the yarn is configured to be woven into a woven fabric with the fire resistant component maintained in the crimped state and the crimping component maintained in the relaxed state.

13. The composite yarn of claim 12, wherein the fire resistant component is in a sinusoidal shape in the crimped state, where the crimped state of the fire resistant component is configured to have a tailored crimp based ono a desired use of the intumescent material.

14. The composite yarn of claim 12, wherein:
the crimping component is a stretchy fiber, wherein the composite yarn is manufactured by stretching the stretchy fiber and bonding the fire resistant component to the stretched stretchy fiber, whereby, when the stretchy fiber is relaxed to the relaxed state, the fire resistant component is crimped to the crimped state;
the crimping component is the stretchy fiber, the composite yarn is manufactured by overwrapping the stretchy fiber with the fire resistant component, where the fire resistant component takes an S-form with the stretchy fiber in a relatively straight state and the fire resistant component in an S-configuration, wherein:
dimensions of the S-form are configured to be modified by altering a relative tension of the stretchy fiber and the fire resistant component; and
a frequency of cross-overs of the stretchy fiber are configured to be adjusted to increase or decrease a difference in length between an s-length of the fire resistant component and a straight length of the stretchy fiber;
the crimping component is the stretchy fiber, the composite yarn is manufactured by braiding the stretchy fiber with the fire resistant component, where the stretchy fiber is braided in a stretched state with a constant tension applied for a desired amount of stretch for the composite yarn, and once braided, the stretchy fiber is relaxed where it contracts and causes the fire resistant component to crimp and form an S-configuration;
the crimping component is a melt-able yarn, wherein the composite yarn is produced by lining the melt-able yarn along the fire resistant component, heating the lined melt-able yarn, running the lined melt-able yarn and fire resistant component between two partially meshed gears where they are crimped and cooling the crimped melt-able yarn and fire resistant component, resulting in a crenulated or crimped composite yarn that is maintained in the crimped state by the solidified melt-able yarn;
the crimping component is a thermoplastic coating, where the composite yarn is produced by coating the thermoplastic coating on the fire resistant component, heating the coated fire resistant component, running the coated fire resistant component between the two partially meshed gears where they are crimped and cooling the crimped coating fire resistant component, resulting in a crenulated or crimped composite yarn that is maintained in the crimped state by the solidified thermoplastic coating;
or
combinations thereof.

15. The composite yarn of claim 12, wherein:
the fire resistant component is made from a fire resistant material and includes a continuous filament; or
the crimping component is a synthetic fiber with elasticity configured to stretch up to five times its length.

16. The composite yarn of claim 15, wherein:
the fire resistant material of the fire resistant component carbon or fiberglass, wherein the carbon is a fully carbonized carbon filament fiber with a useful temperature of between 1000 degrees Fahrenheit and 3000 degrees Fahrenheit; or
the synthetic fiber is a polyether-polyurea copolymer fiber, a specially formulated polyester, or a specially formulated nylon, wherein the polyether-polyurea copolymer fiber is a spandex fiber or elastane fiber.

17. The composite yarn of claim 12, wherein the crimping component is not made from a second fire resistant material and has a melting temperature of between 200 degrees Fahrenheit and 400 degrees Fahrenheit.

18. A reinforced intumescent coating for a structure comprising:
a woven fabric comprising a plurality of composite yarns, each composite yarn including:
a fire resistant component; and
a crimping component bonded to the fire resistant component, where the fire resistant component is in a crimped state and the crimping component is in a relaxed state when bonded;
the woven fabric is woven with each of the composite yarns with the fire resistant component maintained in the crimped state and the crimping component maintained in the relaxed state;
an intumescent material, where the woven fabric is imbedded in the intumescent material;
wherein, when the woven fabric is imbedded in the intumescent material, the woven fabric is configured to reinforce the intumescent material during heat expansion, and mechanical loads from the expanding intumescent material, in a controlled and predictable manner;
whereby, when the reinforced intumescent material is applied to the structure, the reinforced intumescent material is configured to protect the structure from fire and extreme heat.

19. The reinforced intumescent coating of claim 18, wherein:
when the woven fabric imbedded in the intumescent material is subjected to heat where the intumescent material expands, forces of expansion of the intumescent material act on the composite yarns, where the crimping component of each composite yarn is configured to expand or soften thereby straightening the crimped state of the fire resistant component;
when the woven fabric is imbedded in the intumescent material and reaches a decomposition point or a melt point of the crimping component, the crimping component is configured to fully release the crimped state of the fire resistant component to fully extend where it is configured to carry the full load of the expanding intumescent material while remaining imbedded therein;
or
combinations thereof.

20. The reinforced intumescent coating of claim 18, wherein:
the fire resistant component is a fully carbonized carbon filament fiber with a useful temperature of between 1000 degrees Fahrenheit and 3000 degrees Fahrenheit; and
the crimping component is not made from a second fire resistant material and has a melting temperature of between 200 degrees Fahrenheit and 400 degrees Fahrenheit;
whereby, the reinforced intumescent coating is configured to protect the structure from fire and extreme heat of temperatures of approximately 1100 degrees Fahrenheit.
